(19) United States
(12) Patent Application Publication
(10) Pub. No.: US 2010/0071257 A1
(43) Pub. Date: Mar. 25, 2010

(54) Illuminating Device and system for Killing and/or Intefering with Pests, and Method for Killing and/or Interfering with Pests

(76) Inventor: SHANG-CHIEH TSAI, Sihu Township (TW)

Correspondence Address: HDLS Patent & Trademark Services, P.O. BOX 220746, CHANTILLY, VA, 20153-0746, US

(21) Appl. No.: 12/234,629

(22) Filed: Sep. 20, 2008

(51) Int. Cl. A01M 1/04

(52) U.S. Cl. 43/113

(57) ABSTRACT

An illuminating device for killing and/or interfering with pests, which includes at least one light emitting diode for producing more than one non-parallel integrated pulse light that is centralized in a narrow wave band. A wavelength of the integrated light is in a range from 584 nm to 618 nm, a frequency thereof is in a range from 514 THZ to 485 THZ, and a view angle thereof is less than 45 degrees. In addition, an illuminating system for killing and/or interfering with pests includes a drive for driving the illuminating device to emit the integrated pulse light. Also, a method for killing and/or interfering with pests is provided. The method utilizes above illuminating device and system to produce a non-continuous, non-parallel integrated pulse light to kill, interfere with or dispel insect pest.

### BACKGROUND

The present invention relates to a device for killing and/or interfering with pests and particularly to an illuminating device for killing and/or interfering with pests, a system including the illuminating device, and a method for killing and/or interfering with pests using the device and the system.

Most foods of human being depend on agricultural production. Nowadays, to improve an output, appearance, and value of crops, farmers frequently use pesticides to kill or dispel pests during a growth period of crops. However, overuse of pesticides may cause pollution, destroy of environment and soil. Additionally, inappropriate type or amount of pesticides also causes a high level of pesticide residues in farm produces, which finally harm health of people.

Conventionally, yellow bulbs or lamps have been used as bait to attract pests such as mosquitoes and moths. Generally, these bulbs and lamps include yellow coatings on their surfaces. The yellow coatings filter light whose wavelength is less than 450 nm out of the whole spectra. Although these bulbs and lamps can produce light beams in yellow light spectra which has a wavelength of 520 nm˜630 nm and also irradiate in a dispersing and continuous manner; however, limited to physical characteristic of filaments, these bulbs and lamps have poor performance in preventing insect pest.

Up until now, lamps of this type works a little in preventing insect pest, however, it is insufficient for practical use in agricultural production. Thus, except research institutions, farmers rarely use these lamps to prevent insect pest.

Therefore, the inventor of this application has done a deep research in aforementioned shortages of these lamps for killing pests and tried to overcome the problems. After a long period of research and development, the inventor developed the illuminating device and system for killing and/or interfering with pests, and a method for killing pests.

### BRIEF SUMMARY

The present invention provides an illuminating device for killing and/or interfering with pests, which includes at least one light emitting diode for producing more than one non-parallel integrated pulse light that is centralized in a narrow wave band. A wavelength of the integrated light is in a range from 584 nm to 618 nm, a frequency thereof is in a range from 514 THZ to 485 THZ, and a view angle thereof is less than 45 degrees.

In one embodiment of the illuminating device, the wavelength of the integrated light can be 600 nm and the frequency of the integrated light can be 500 THZ.

In one embodiment of the illuminating device, the view angle is in a range from 10 degrees to 30 degrees.

The present invention also provides an illuminating system for killing and/or interfering with pests, which includes at least one light emitting diode, a drive for providing a voltage to drive the light emitting diode to emit an integrated light.

In the illuminating system, the drive includes:

a flicker circuit for driving the light emitting diode to emit flickering integrated pulse light; and a power supply for providing a stable voltage to the flickering circuit.

In one embodiment of the illuminating system for killing and/or interfering with pests, the drive is preferably is a power supply.

In one embodiment of the illuminating system for killing and/or interfering with pests, a photosensitive switch is disposed between the drive and the light emitting diode.

In one embodiment of the illuminating system for killing and/or interfering with pests, the flicker circuit includes a photosensitive resistor for activating or deactivating the flicker circuit according to a brightness of outer light.

The present invention also provides a method for killing and/or interfering with pests. The method includes the steps of:

(1) providing at least one narrow pulse that is centralized in yellow light spectra or near-yellow light spectra, which has a wavelength in a range from 584 nm to 618 nm and a frequency in a range from 514 nm to 485 nm;

(2) driving at least one light emitting diode to emit a non-continuous, non-parallel integrated pulse light has a view angle less than 45 degrees; and

(3) irradiating pests using the non-continuous, non-parallel integrated pulse light.

In one embodiment of the method for killing and/or interfering with pests, a flickering frequency of the non-continuous, non-parallel integrated pulse light is controlled in a range from 1 to 5 times per second.

In one embodiment of the method for killing and/or interfering with pests, a flickering frequency of the non-continuous, non-parallel integrated pulse light is 3 times per second.

In one embodiment of the method for killing and/or interfering with pests, a light intensity of the non-continuous, non-parallel integrated pulse light is controlled to be larger than 10000 mcd.

The present invention utilizes light emitting diodes to emit a non-parallel integrate pulse light and particularly flickering integrated pulse light to kill pests. After a long period of experiments, it is found that the illuminating device, system, and method are effective in killing and/or interfering with cockroach, diversified larvae of the early, diamondback, cutworm, rice and corn borer, silverleaf whitefly, budworm, coccid, coleoptera, testa insects. Imagoes can't normally move and copulate with the others, and larvae can't take food until die of starvation. Thus insect pest is inhibited and there is no need to use pesticides.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of an illuminating system for killing and/or interfering with pests of the present invention;

FIG. 2 is a circuit diagram of an illuminating system for killing and/or interfering with pests in accordance with a first embodiment of the present invention;

FIG. 3 is a circuit diagram of an illuminating system for killing and/or interfering with pests in accordance with a second embodiment of the present invention;

FIG. 4 is a circuit diagram of an illuminating system for killing and/or interfering with pests in accordance with a third embodiment of the present invention;

FIG. 5 is a circuit diagram of an illuminating system for killing and/or interfering with pests in accordance with a fourth embodiment of the present invention;

FIG. 6 is a schematic view showing appearance of an LED assembly in the illuminating system for killing and/or interfering with pests of the present invention;

FIG. 7 is a schematic view showing appearance of another LED assembly in the illuminating system for killing and/or interfering with pests of the present invention;

FIG. 8 is a schematic view illustrating a top view of an arrangement of a number of LED assembles of FIG. 7 around crops; and

FIG. 9 is a schematic view showing that the illuminating system for killing and/or interfering with pests of the present invention is used in a cockroach trap.

### DETAILED DESCRIPTION

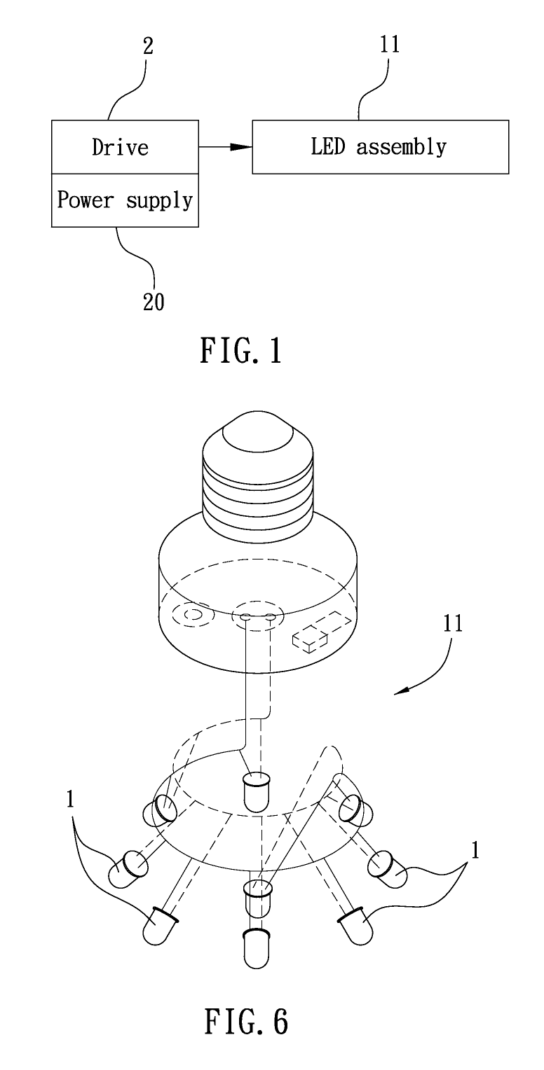

Referring to FIG. 1, the present invention provides an illuminating system for killing and/or interfering pests, which includes a group of light emitting diode (LED) assembly 11, and a group of drives 2.

The LED assembly 11 includes at least one light emitting diode 1. Alternatively, the light emitting diode 1 can be also a laser diode (LD). The light emitting diode 1 can produce a non-parallel integrated light, which includes more than one light beams in a narrow wave band. The light beams are centralized in a pulse, and the wavelength of the light beams is in the yellow or near-yellow spectra. The integrated light is suitable for interfering with or killing insect pests. A wavelength of the integrated light is in a range from 584 nm to 618 nm, and preferably 600 nm. A frequency of the integrated light is in a range from 514 THZ to 485 THZ, and preferably 500 THZ. A view angle of the integrated light is less than 45 degrees, and preferably in a range from 15 degrees to 30 degrees. The LED assembly 11 may include LED 1 having different wavelengths to form LED assembly 11 in different wave bands for different applications.

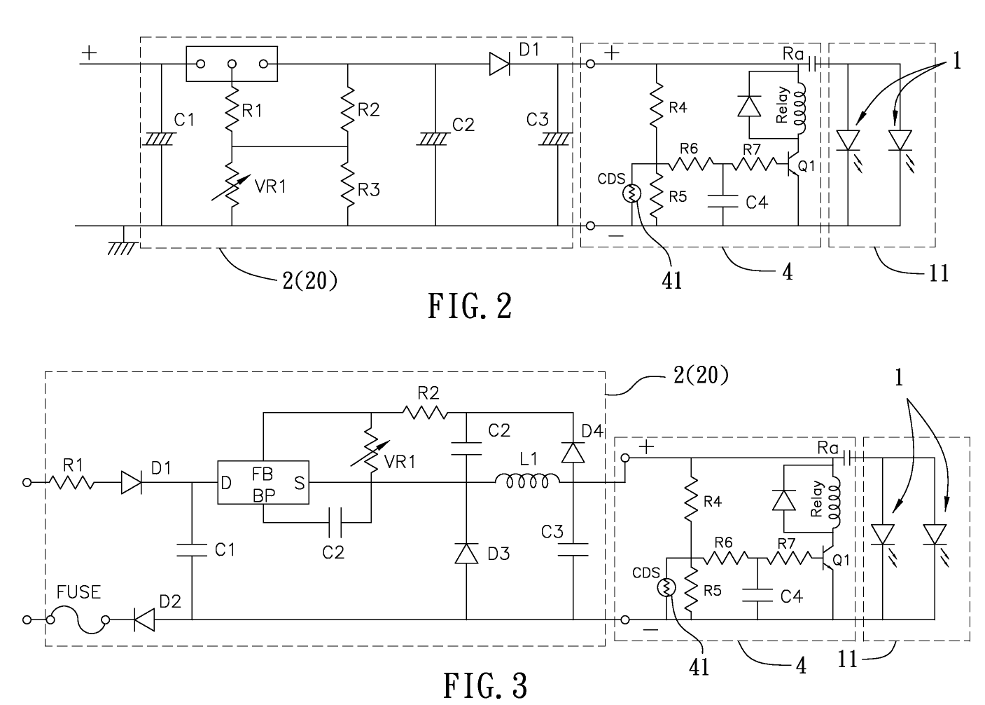

Referring to FIGS. 2 and 3, which illustrate a circuit diagram of an illuminating system for killing and/or interfering with insect pests in accordance with a second embodiment, the illuminating system includes a drive 2 and the LED assembly 11. The drive 2 is mainly used to drive the LED assembly 11 to produce the integrated light. In the second embodiment, the drive 2 is a power supply 20. The power supply 20 shown in FIG. 2 is a typical direct current (DC) regulator circuit, and the power supply in FIG. 3 is a typical alternating current (AC) regulator circuit.

In addition, a photosensitive switch circuit 4 is disposed between the drive 2 and the LED assembly 11. The photosensitive switch circuit 4 has a photosensitive resistor 41. A resistance of the photosensitive resistor 41 is at a high level when there is no other light source, and resistors R4, R5 in the photosensitive switch circuit 4 form a bleeder circuit thereby applying a positive bias on the transistor Q1 to electrically conduct the transistor Q1. The relay “Relay” is actuated, the normally open contact Ra is closed thereby powering the LED 1 to emit light. The resistance of the photosensitive resistor CDS is at a low level when there is daylight or other light source, the transistor Q1 is electrically isolated. The relay “Relay” doesn't act, and the LED 1 doesn't emit light. It is to be understood that photosensitive circuit 4 can also be omitted. In this instance, the illuminating system works in any light environment.

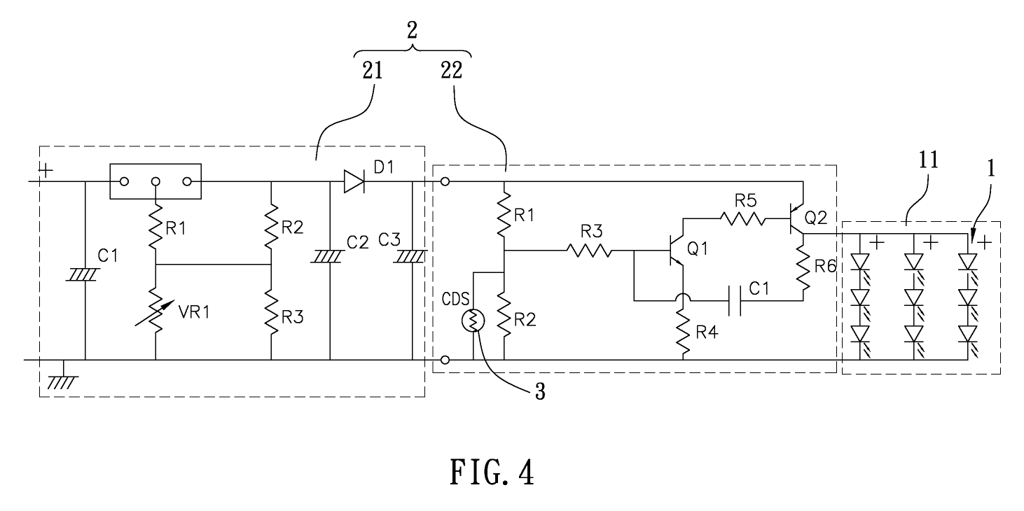

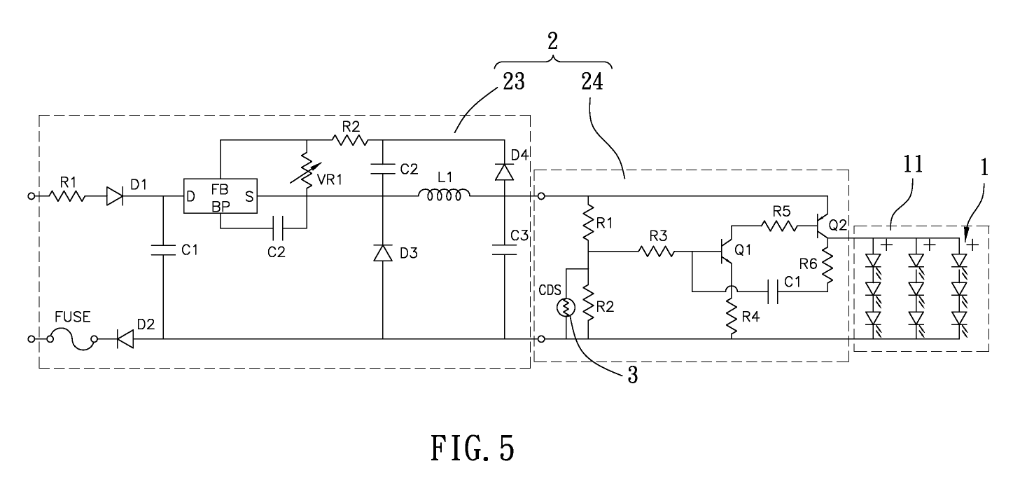

FIGS. 4 and 5 illustrate another two embodiments of an illuminating system for killing and/or interfering with pests, which includes the drive 2 and the LED assembly 11. The drive 2 in FIG. 4 includes a power supply having a DC regulator circuit 21, and a flicker circuit 22. The flicker circuit 22 is configured for driving the LED assembly 11 to produce flickering integrated light pulses, and the DC regulator circuit 21 provides a stable voltage to the flicker circuit 22. The drive 2 in FIG. 5 includes a power supply having an AC regulator circuit 23, and a flicker circuit 24. The flicker circuit 24 is same to the flicker circuit 22, and is configured for driving the LED assembly 11 to produce flickering integrated light pulses. The DC regulator circuit 23 provides a stable direct voltage to the flicker circuit 24.

The illuminating systems in FIGS. 4 and 5 both include a photosensitive switch 3 mainly comprised of a photosensitive resistor CDS. The photosensitive switch 3 can close the drive 2 under daylight and activate the drive 2 in the night or there is no daylight. Thus, the illuminating system automatically starts to work in the night, shuts down in the day. However, some insect pest also occurs during the day. In this instance, the photosensitive resistor CDS can be omitted, and the illuminating system can work all the time.

In a practical application, the aforementioned circuits can be integrated in an integrated circuit.

FIG. 6 illustrates an arrangement of the LED assembly 11 in the illuminating system for killing and/or interfering with pests. The LED assembly 11 includes a number of radially disposed light emitting diodes distributed in a number of layers, and the layers are spaced apart from each other such that the light from the LED assembly 11 can cover a large area. The drive 2 can be mounted in a heat portion (not shown) of the LED assembly 11.

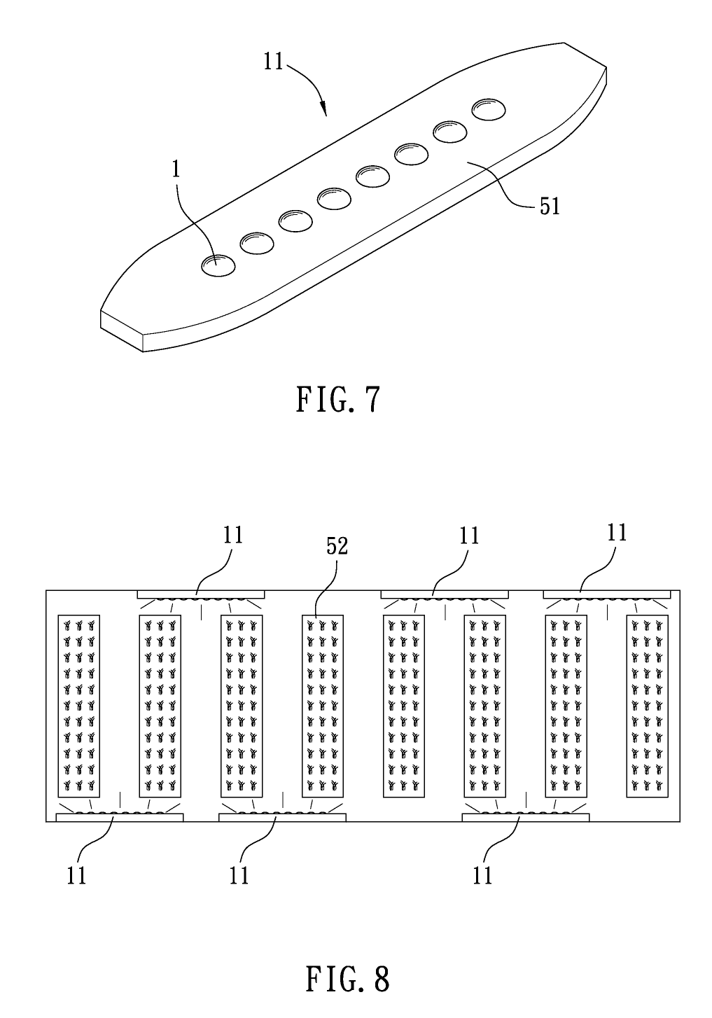

FIG. 7 shows another embodiment of the LED assembly 11, in which a number of LEDs 1 are mounted on a rectangular housing. The LEDs 1 are high power light emitting diodes and are capable of irradiating a large area. Also, the drive 2 can be mounted in the housing 51.

FIG. 8 illustrates a top view of an arrangement of a number of LED assembles 11 of FIG. 7 around crops 52.

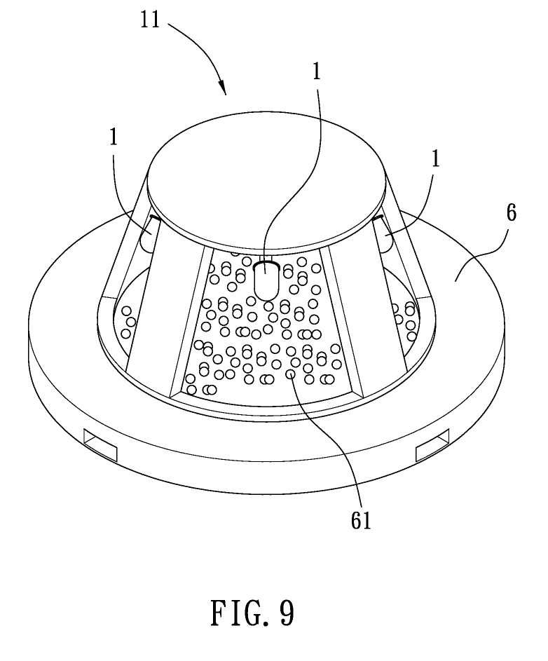

FIG. 9 illustrates that the illuminating system of the present invention is used to killing cockroaches. The LED assembly 11 is mounted in a cockroach trap 6. A number of baits 61 are also disposed in the cockroach trap 6 to attract cockroaches so as to irradiate them using the LED assembly.

The present invention also provides a method for killing and/or interfering with pests using aforementioned illuminating device and system.

In step (1), at least one narrow pulse is provided. The narrow pulse is centralized in the yellow light spectra or near-yellow light spectra. A wavelength of spectra is in a range from 584 nm to 618 nm, and preferably 600 nm. A frequency of the spectra is in a range from 514 THZ to 485 THZ, and preferably 500 THZ.

In step (2), a non-continuous, non-parallel integrated pulse light is emitted by driving at least one light emitting diodes. A view angle of the integrated light is less than 45 degrees. Test results show that more less the view angle is, better efficiency of the illuminating system is obtained. However, an effective irradiating area of the illuminating system also reduces. Thus, the view angle is preferred to be in a range from 10 degrees to 30 degrees such that the illuminating system has a relative high efficiency of killing pests and a relative large irradiating area.

In step (3), pests are irradiated using the non-continuous, non-parallel integrated pulse light.

In the method, a flicker frequency of the non-continuous, non-parallel integrated pulse light is in a range from 1 to 3 times per second and preferably 3 times per second.

In addition, a light intensity of the illuminating system is controlled to be larger than 10000 mcd.

The present invention utilizes light emitting diodes to emit a non-parallel integrated pulse light that is centralized in a narrow wave band to kill and/or interfere with pests. The integrated pulse light can interfere with activity and copulation of pests, and even dispel or kill the pests. Compared to conventional bulbs or lamps, the view angle of the integrated light is less than 45 degrees, which results in a significant advancement in performance of killing pests.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An illuminating device for killing and/or interfering with insects, comprising:
at least one light emitting diode for producing more than one non-parallel integrated light that is centralized in a pulse of a narrow wave band, wherein a wavelength of the integrated light is in a range from 584 nm to 618 nm, a frequency of the integrated light is in a range from 514 THZ to 485 THZ, and a view angle of the integrated light is less than 45 degrees.

2. The illuminating device as claimed in claim 1, wherein the view angle of the integrated light is in a range from 10 degrees to 30 degrees.

3. The illuminating device as claimed in claim 1, wherein the wavelength of the integrated light is 600 nm, and the frequency of the integrated light is 500 THZ.

4. An illuminating system for killing and/or interfering with insects, comprising:
at least one light emitting diode for producing more than one non-parallel integrated light that is centralized in a pulse of a narrow wave band, wherein a wavelength of the integrated light is in a range from 584 nm to 618 nm, a frequency of the integrated light is in a range from 514 THZ to 485 THZ, and a view angle of the integrated light is less than 45 degrees; and
a drive for providing a voltage to power the light emitting diode to emit the integrated light.

5. The illuminating system as claimed in claim 4, wherein the drive comprises:
a flicker circuit for driving the light emitting diode to produce flickering integrated light pulse; and
a power supply for providing a stable voltage to the flicker circuit.

6. The illuminating system as claimed in claim 4, wherein the drive is a power supply.

7. The illuminating system as claimed in claim 4, wherein a photosensitive switch is arranged between the drive and the light emitting diode, and the photosensitive switch is configured for turning on or shutting down the light emitting diode according to the brightness of ambient environment.

8. The illuminating system as claimed in claim 5, wherein the flicker circuit comprises a photosensitive resistor for activating or deactivating the flicker circuit according to the brightness of ambient environment.

9. A method for killing and/or interfering with insects, comprising:
providing at least one pulse of light in a narrow wave band, the light being centralized in a wave band of yellow light spectra or near-yellow light spectra, a wavelength of the light being in a range from 584 nm to 618 nm, a frequency of the integrated light being in a range from 514 THZ to 485 THZ;
driving at least one light emitting diode to emitting a pulse of non-continuous, non-parallel integrated light, a view angle of the integrated light being less than 45 degrees; and
irradiating pests with the non-continuous, non-parallel integrated pulse light.

10. The method as claimed in claim 9, wherein a flicker frequency of the non-continuous, non-parallel integrated pulse light is in a range from 1 to 5 times per second.

11. The method as claimed in claim 9, wherein a flicker frequency of the pulse of non-continuous, non-parallel integrated light is 3 times per second.

12. The method as claimed in claim 9, wherein an intensity of the integrated light is larger than 10000 mcd.

13. The method as claimed in claim 9, wherein a view angle of the integrated light is in a range from 10 degrees to 30 degrees.
